(19) United States
(12) Patent Application Publication
(10) Pub. No.: US 2023/0127480 A1
(43) Pub. Date: Apr. 27, 2023

(54) Device And Method of Use for Mapping Out the Layout of a Room Without Human Presence

(71) Applicant: Lucas Matte, Evansville, IN (US)

(72) Inventor: Lucas Matte, Evansville, IN (US)

(21) Appl. No.: 17/974,752

(22) Filed: Oct. 27, 2022

Related U.S. Application Data
(60) Provisional application No. 63/272,473, filed on Oct. 27, 2021.

(51) Int. Cl. G01S 17/89; G01S 15/89; G01S 7/481

(52) U.S. Cl. CPC G01S 17/89; G01S 15/89; G01S 7/4817

(57) ABSTRACT

A system is capable of scanning the layout of a room and a method for its usage. In a typical embodiment, the system consists of a mobile device that utilizes a distance sensor(s). The mobile device and/or sensor(s) rotate and travel around a room, providing multiple distance calculations that convert to degree arrays and obstacle arrays, mapping out the layout of the room without human presence.

### RELATED APPLICATIONS

The application claims the benefit of U.S. Provisional Patent Application No. 63/272,473, filed Oct. 27, 2021, naming Lucas Matte, and titled “Device & Method of Use for Mapping Out the Layout of a Room Without Human Presence,” the entire disclosure of which is expressly incorporated by reference herein.

### FIELD OF DISCLOSURE

The present disclosure is directed to a mobile device. More specifically, this disclosure describes a mobile device that maps the layout of a room.

### BACKGROUND AND SUMMARY OF PRESENT DISCLOSURE

The present disclosure relates to a system for scanning the layout of a room using a mobile device affixed with sensor(s) and a microcontroller. The sensor(s) emit sound waves and time of flight infrared laser light waves as the mobile device rotates. The waves reverberate off of walls and objects in the room and return to the sensor(s). Based on the time it takes for the waves to travel back to the sensor(s), the mobile device can calculate the distance between itself and the objects in the room. In some embodiments, the mobile device records distance data for entire rooms using 360-degree sensing capabilities. The mobile device stores distance data for a given point. If, according to the distance data, there is a sudden change in recorded distance between two degrees, there may be an object in the room. The mobile device will travel to different parts of the room and repeat the same emitting, receiving, and calculating steps until an accurate layout of the room can be generated.

### BRIEF DESCRIPTION OF THE DRAWINGS

The detailed description of the drawings particularly refers to the accompanying figures in which:

FIG. 1 is a side view of a mobile device according to the present disclosure.

FIG. 2 is a front view of the mobile device of FIG. 1.

FIG. 3 is a rear view of the mobile device of FIG. 1 showing an ultrasonic distance sensor.

FIG. 4A is a diagrammatic top view of one embodiment of the mobile device with axles in a first position.

FIG. 4B is a view similar to FIG. 4A with the axles in a second position.

FIG. 5 is a top view of a scanning operation of an embodiment of the mobile device in a room with an object showing a path the mobile device may travel to wave emitting positions around the room.

FIG. 6 is a top view of a scanning operation of the mobile device at, a first, wave emitting position showing the mobile device detecting the object and walls within the room and recording surfaces to create a first degree array.

FIG. 7 is a view similar to FIG. 6 with the mobile device at a second wave emitting position showing the mobile device detecting the object and walls within the room from the second wave emitting position and recording surfaces to create a second degree array.

FIG. 8 is a top view of an obstacle array showing the surfaces in the room, with the obstacle array created by combining the first degree array from FIG. 6 and the second degree array from FIG. 7.

FIG. 9 is a flow chart showing a mapping operation method of one embodiment of the mobile device.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. Unless otherwise indicated or apparent, the components shown in the figures are proportional to each other. It will be understood that no limitation of the scope of the disclosure is thereby intended. The disclosure includes any alterations and further modifications in the illustrative devices and described methods and further applications of the principles of the disclosure, which would normally occur to one skilled in the art to which the disclosure relates.

### DETAILED DESCRIPTION OF THE DRAWINGS

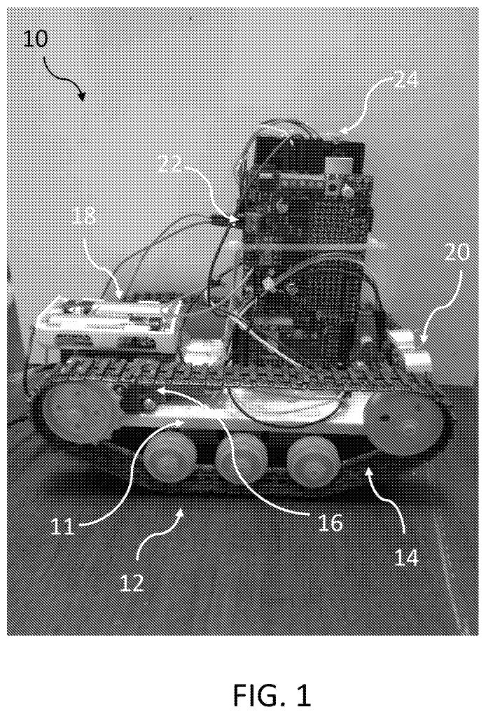

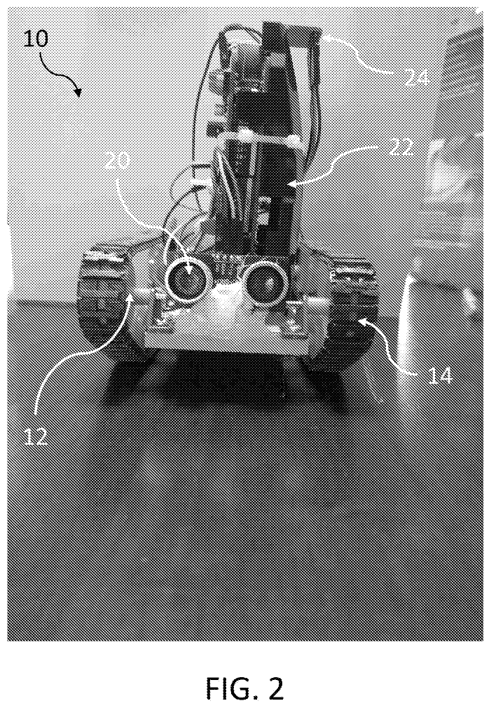

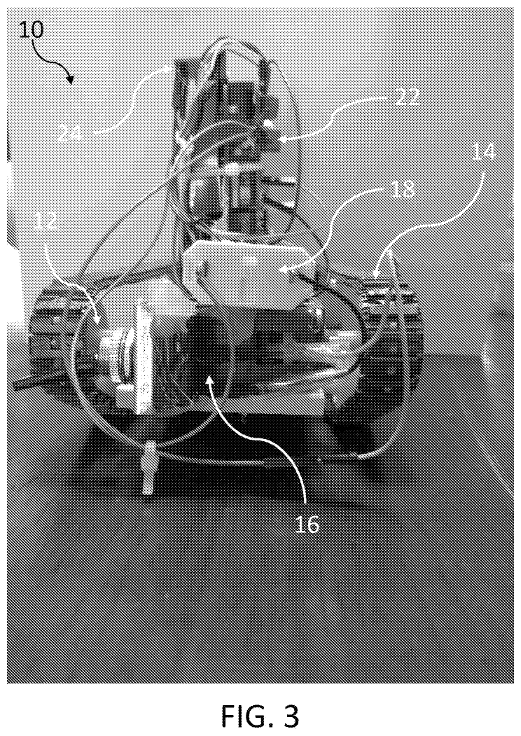

As depicted in FIGS. 1-3, mobile device 10 is provided for mapping the layout of a room 38. Mobile device 10 measures the distance to walls 47 and object(s) 48 from various positions within room 38 and uses the distance measurements to create a map of room 38. Based on the map. a user can know the layout of room 38.

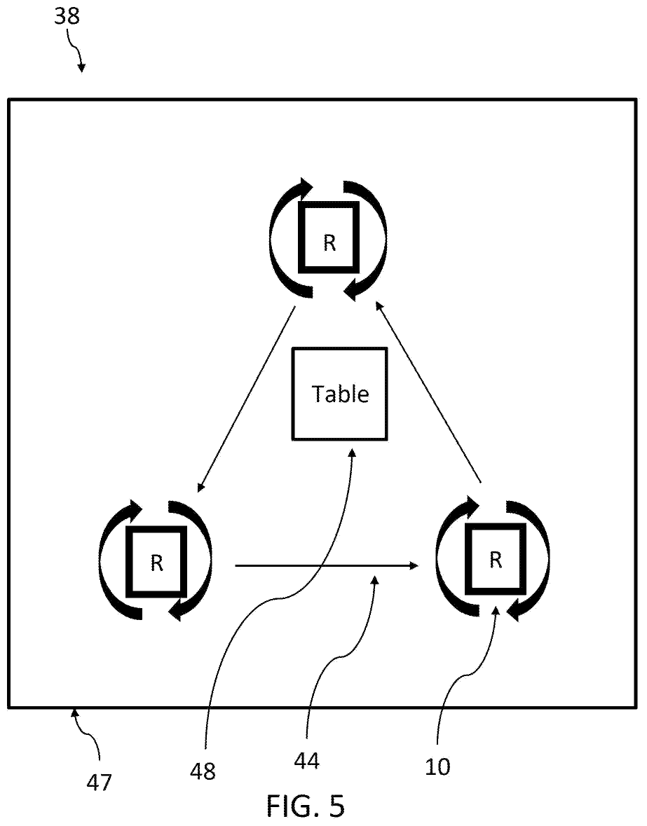

Mobile device 10 includes a frame 11, a plurality of wheels 12, and a pair of treads 14. Plurality of wheels 12 rotate pair of treads 14, causing mobile device 10 to move forward, backward, or rotate in place. According to alternative embodiments, treads may not be provided and wheels or other ground-engaging elements may move the mobile device. Mobile device 10 uses a motor 16 powered by a plurality of batteries 18 to drive wheels 12 forward and backward, allowing mobile device 10 to rotate 360 degrees while staying in the same position. As shown in FIG. 5, mobile device 10 includes an ultrasonic distance sensor(s) and a time of flight infrared laser light sensor(s) 20 that emits sound waves and time of flight infrared laser light waves 46, receives sound waves and time of flight infrared laser light waves 50 reverberated off of walls 47 and objects 48, and sends a signal to a microcontroller 22. Microcontroller 22 converts distance information received by ultrasonic distance sensor(s) and time of flight infrared laser light sensor(s) 20 based on reverberated sound waves 50 into an X,Y coordinate plane.

Mobile device 10 includes one, two. or more compass module(s) 24 that detects the position of mobile device 10 in space by measuring the strength and direction of the magnetic field at a point in space. Compass module(s) 24 sends a position signal to microcontroller 22. Based on the signal received from compass module(s) 24, microcontroller 22 can determine the location of mobile device 10 within room 38. This position information provides context to the distance information retrieved by mobile device 10 and also allows mobile device 10 to determine whether a part of room 38 has already been scanned. According to alternative embodiments, the location of mobile device 10 within room 38 may be determined by a global positioning system (GPS). In this alternative embodiment, mobile device 10 is fixed with a GPS. This may enable external human operators to manually control mobile device 10 and guide mobile device 10 to unexamined areas of room 38.

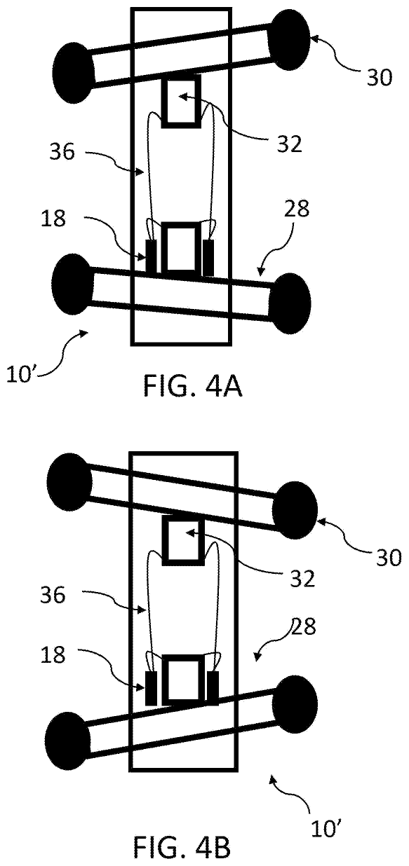

As depicted in FIG. 4A, an embodiment of a mobile device 10′ with steering motors 32 is provided. Wheels 30 and axles 28 are shown in a first position. Axles 28 are separately controlled by steering motors 32 which allow mobile device 10′ to turn. Mobile device 10′ is capable of rotating 360 degrees in either direction with little change in position within a room. Plurality of batteries 18 are coupled to a plurality of electric wires 36 that extend to steering motors 32 to turn mobile device 10′. As depicted in FIG. 4B, wheels 30 and axles 28 are shown in a second position. Wheels 30 and axles 28 change position, allowing mobile device with steering motors 26 to turn.

According to alternative embodiments, ultrasonic distance and time of flight infrared laser light sensor(s) 20 are affixed to a rotating servomechanism (servo), not shown, enabling ultrasonic distance and time of flight infrared laser light sensor(s) 20 to rotate while mobile device 10 remains fixed. In this alternative embodiment, mobile device 10 does not need to turn while making a 360-degree scan. The rotating servo makes the 360-degree turn instead of mobile device 10, and ultrasonic distance and time of flight infrared laser light sensor(s) 20 continuously emit and receive sound waves and time of flight infrared laser light waves as the servo rotates.

In FIG. 5, a scanning operation of mobile device 10 in room 38 is shown. Mobile device 10 moves along a path 44 to various wave emitting positions around room 38. At each wave emitting position, mobile device 10 rotates 360 degrees to complete a scan of room 38. In embodiments where sensor(s) 20 rotates relative to mobile device 10, sensor(s) 20 rotates relative to mobile device 10 during this step. The scan of room 38 detects objects 48 and walls 47 within room 38. For example, scan of room 38 will detect table object 48 and wall 47. Mobile device 10 continues to move around room 38 to various wave emitting positions until a complete scan of room 38 is done. For illustrative purposes, only a single object 48 is shown in room 38. In an alternative embodiment, multiple objects within a room may be detected.

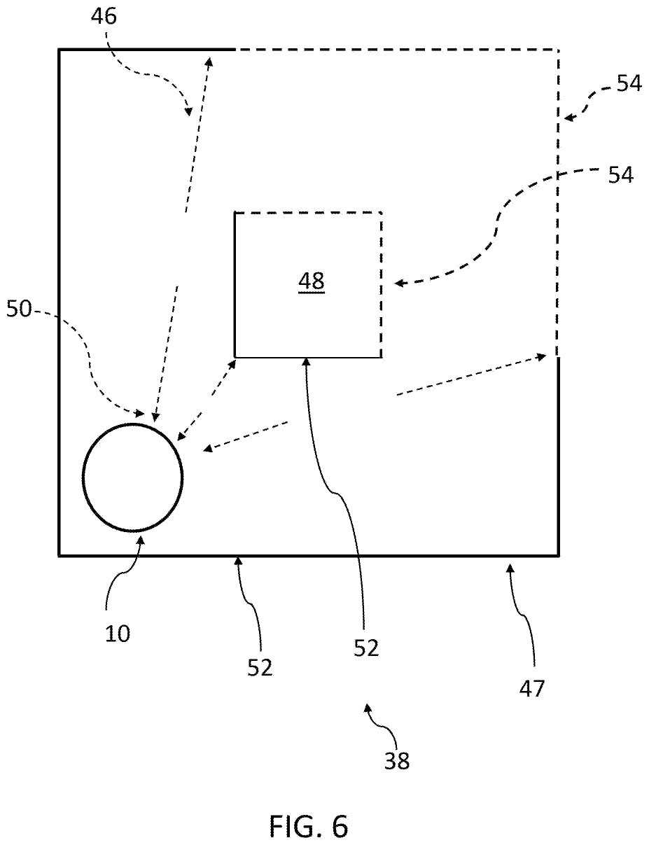

FIG. 6 shows the scanning operation of mobile device 10 at a first wave emitting position. The scanning operation begins with ultrasonic distance and time of flight infrared, laser light sensor(s) 20 of mobile device 10 emitting sound and time of flight infrared laser light waves 46 of a single wavelength in room 38. Sound and time of flight infrared laser light waves 46 travel to and reverberate off of objects 48 and walls 47 within room 38. Reverberated sound waves 50 travel back to and are received by ultrasonic distance and time of flight infrared laser light sensor(s) 20. Upon receiving reverberated sound and light waves 50, ultrasonic distance and time of flight infrared laser light sensor(s) 20 send a signal to microcontroller 22. With the signal, microcontroller 22 calculates the distance between mobile device 10 and objects 48 and walls 47 within room 38 using the time difference between when sound and light waves 46 were emitted by ultrasonic distance sensor(s) and time of flight infrared laser light sensor(s) 20 and when reverberated sound and light waves 50 were received by ultrasonic distance and time of flight infrared laser light sensor(s) 20. At the first wave emitting position, as shown in FIG. 6, mobile device 10 rotates 360 degrees, or sensor(s) 20 rotate relative to mobile device 10 as discussed above.

Mobile device 10 repeats the emitting, receiving, and calculating steps at each degree in the 360-degree rotation. The calculated distances between mobile device 10 and objects 48 and walls 47 within room 38 at the first, wave emitting position at each degree of the rotation are combined in a degree array. When there is a sudden change in calculated distances between two degrees of rotation, mobile device 10 has detected object 48 or wall 47 within room 38. Object 48 or wall 47 is stored as a detected surface 52 in the degree array. Detected surfaces 52 are shown with solid lines.

Object 48 within room 38 may block other surfaces from being detected because object 48 blocks sound waves 46 from continuing further into room 38. This leads to mobile device 10 not detecting certain surfaces. An undetected surface 54 is not stored in the degree array. Undetected surfaces 54 are shown with dashed lines.

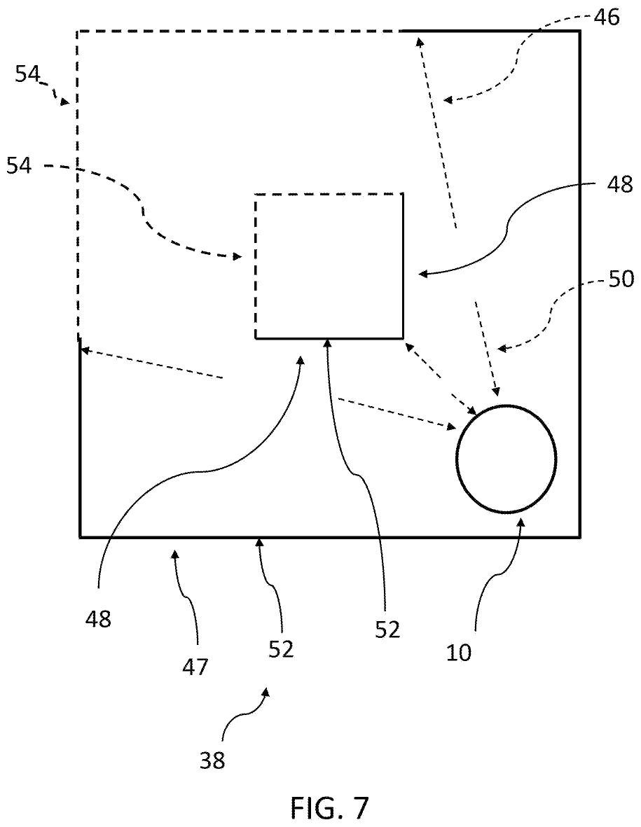

As depicted in FIG. 7. after calculating distances at the first wave emitting position, mobile device 10 moves along path 44, as shown in FIG. 5, to the second wave emitting position within room 38 to potentially detect undetected surfaces 54 (which were not detectable from the first wave emitting position). Mobile device 10 then conducts another 360-degree scan and forms another degree array showing detected surfaces 52.

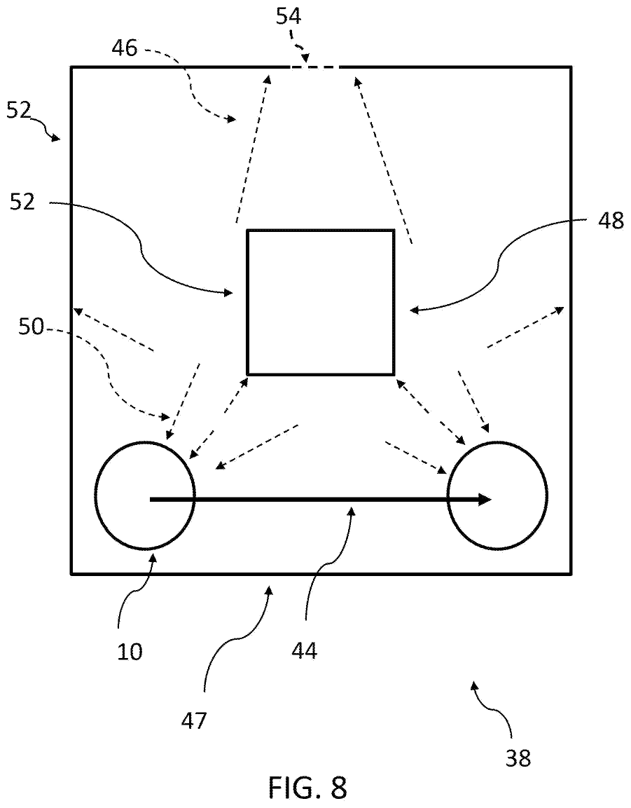

As depicted in FIG. 8, after mobile device 10 has completed multiple scans of room 38 from different wave emitting positions, the degree arrays from FIG. 6 and FIG. 7 are combined into an obstacle array. New data is added to obstacle array after each degree array is completed at each wave emitting position. By calculating the location of walls 47 and objects 48 relative to mobile device 10, microcontroller 22 is able to build a complete X, Y coordinate plane of room 38 consisting of all walls 47 and object(s) 48 within it, as shown by obstacle array.

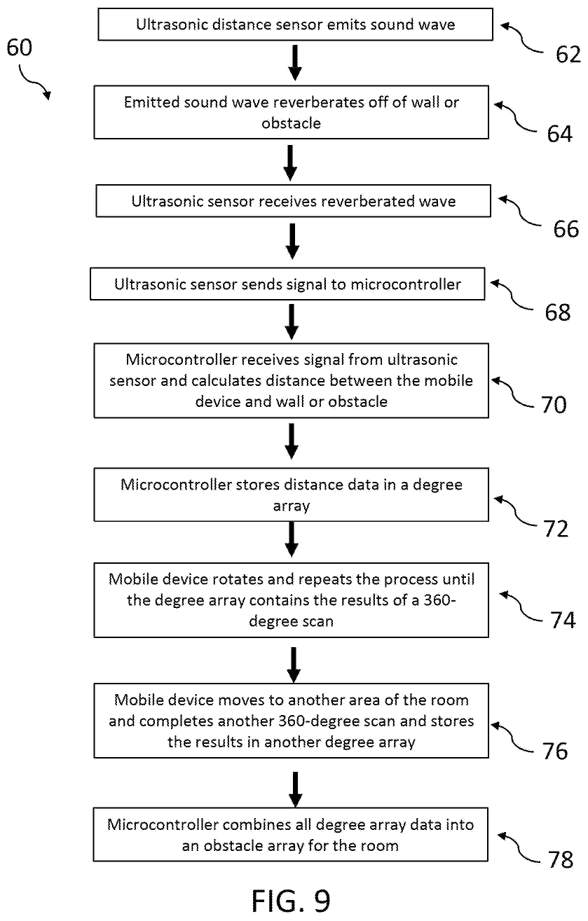

FIG. 9 shows diagrammatically a mapping operation method 60 of one embodiment of mobile device 10, as also described elsewhere herein. Method 60 begins with wave emitting step 62. At wave emitting step 62, ultrasonic distance and time of flight infrared laser light sensor(s) 20 emit sound and light waves 46 within room 38. Sound waves and light waves 46 travel to objects 48 and walls 47 within room 38.

After wave emitting step 62, wave reverberation step 64 occurs. In wave reverberation step 64, emitted sound and light waves 46 reverberate off of walls 47 and/or objects 48 within room 38 and travel back to ultrasonic distance and time of flight infrared laser light sensor(s) 20.

At wave receiving step 66, reverberated waves 50 are received by ultrasonic distance and time of flight infrared laser light sensor(s) 20. After wave receiving step 66, method 60 proceeds to signaling step 68. During signaling step 68, ultrasonic distance and time of flight infrared, laser light sensor(s) 20 sends a signal to microcontroller 22 based on reverberated waves 50.

After microcontroller 22 receives the signal from ultrasonic distance and time of flight infrared laser light sensor(s) 20, calculation step 70 occurs. Microcontroller 22 calculates the distance between mobile device 10 and objects 48 and walls 47 within room 38 using the time difference between when sound and light waves 46 were emitted by ultrasonic distance and time of flight infrared laser light sensor(s) 20 in emitting step 62 and when reverberated sound and light waves 50 were received by ultrasonic distance and time of flight infrared laser light sensor(s) 20 in receiving step 66.

After calculation step 70, method 60 continues to storage step 72. In storage step 72. microcontroller 22 stores the distance data in a degree array. At rotation step 74, mobile device 10 rotates and repeats wave emitting step 62, wave reverberation step 64, wave receiving step 66, signaling step 68, calculation step 70, and storage step 72 until the degree array contains the results for each degree of a 360-degree scan.

After the 360-degree scan, movement step 76 occurs. Mobile device 10 moves to another area of room 38 on path 44 and completes another 360-degree scan. This results in another degree array for a different position in room 38. In a subsequent combination step 78, microcontroller 22 combines all degree array data into the obstacle array for room 38. Mapping operation method 60 for room 38 is now complete.

What is claimed is:

1. A mobile device including:
a frame;
a traction system supporting the frame;
at least one distance sensor supported by the frame; and
at least one controller configured to control movement of the traction system to move the mobile device to a plurality of locations, the at least one controller in communication with the at least one distance sensor to receive distance information relating to distances detected by the at least one distance sensor and objects detected by the distance sensor as the distance sensor rotates at each of the plurality of locations to create a plurality of degree arrays, the at least one controller being configured to combine the plurality of degree arrays into at least one obstacle array representative of at least one object.

2. A mobile device including:
a frame;
a traction system supporting the frame;
at least one distance sensor supported by the frame;
means to control movement of the traction system to move the mobile device to a plurality of locations;
means to receive distance information relating to distances detected by the at least one distance sensor and objects detected by the distance sensor and objects detected by the distance sensor as the distance sensor rotates at each of the plurality of locations to create a plurality of degree arrays; and
means to combine the plurality of degree arrays into at least one obstacle array representative of at least one object.

3. The mobile device of claim 1, wherein the distance sensor(s) is at least one of an ultrasonic distance sensor and/a time of flight infrared laser light sensor.

4. The mobile device of claim 1, wherein the at least one distance sensor rotates relative to the frame.

5. The mobile device of claim 1, wherein the at least one distance sensor remains stationary relative to the frame.

6. A method including:
providing a mobile device;
placing the mobile device in a room;
emitting waves from a distance sensor connected to the mobile device receiving reverberated waves from walls of the room and objects in the room;
calculating a distance between the mobile device and the walls of the room and objects in the room;
repeating the distance calculations continually as the mobile device rotates;
converting the distance calculations into coordinates on an X,Y plane using a microcomputer to build a degree array;
traveling to different points in the room to emit waves, receive reverberated waves, calculate a distance, repeat distance calculates, convert distance calculations to create a plurality of degree arrays; and
combining the plurality of degree arrays from each point in the room to form an obstacle array showing walls of the room and objects in the room.

7. The method of claim 6, further including using a compass module to detect the current magnetic degree of the mobile device.

8. The method of claim 7, wherein the compass module is used to determine where in the room the mobile device has already calculated distances.

9. The method of claim 6, further including rotating the distance sensor independently of the mobile device to obtain additional distance calculations at different points in the room.
